(19) United States
(12) Patent Application Publication
(10) Pub. No.: US 2025/0125909 A1
(43) Pub. Date: Apr. 17, 2025

(54) END-TO-END CAMERA VIEW VERIFICATION FOR AUTOMOTIVE SYSTEMS AND APPLICATIONS

(71) Applicant: NVIDIA Corporation, Santa Clara, CA (US)

(72) Inventors: Rudolf H. J. BLOKS, Campbell, CA (US); Arun Kumar SWAIN, Morgan Hill, CA (US)

(21) Appl. No.: 18/678,980

(22) Filed: May 30, 2024

Related U.S. Application Data
(60) Provisional application No. 63/544,094, filed on Oct. 13, 2023.

(51) Int. Cl. H04L 1/00

(52) U.S. Cl. CPC H04L 1/0083; H04L 1/0041; H04L 1/0061

(57) ABSTRACT

In various examples, a technique for end-to-end camera view verification for automotive systems and applications includes computing a checksum for at least a portion of a frame to be displayed on a screen, wherein the frame comprises one or more views captured using one or more cameras. The technique also includes receiving a sequence of checksums associated with one or more previous frames displayed on the screen. The technique further includes updating one or more counters based on one or more comparisons of the computed checksum and the sequence of checksums and causing an alert associated with display of the frame on the screen to be generated based on the one or more counters.

### CROSS-REFERENCE TO RELATED APPLICATIONS

This application claims the priority benefit of U.S. Provisional Application No. 63/544,094, filed on Oct. 13, 2023, which is hereby incorporated by reference in its entirety.

### BACKGROUND

A modern car, truck, bus, and/or other type of vehicle or machine may be equipped with a camera—or other sensor-based vision—system that captures various views of the environment around the vehicle. These views can be displayed on a screen of the vehicle to assist a driver with various driving-related tasks and/or to inform the driver or other occupants of the surroundings and/or operations of the vehicle. For example, a rearview camera may be activated when the vehicle is placed in reverse to allow the driver to view roads, pedestrians, vehicles, and/or other objects or obstacles in the path of the vehicle as the vehicle moves backward. In another example, multiple camera views may be transformed, stitched, blended, and/or otherwise combined into a top-down, bird's eye view (BEV), three-dimensional (3D), surround view, and/or another visualization of the vehicle's surroundings while the vehicle is being parked or positioned. The driver may additionally interact with a user interface in the vehicle to rotate the visualization, zoom in or out of the visualization, and/or otherwise change the view or perspective associated with the visualization.

However, the process of rendering and displaying a view of an environment around a vehicle typically involves a complex multi-stage display pipeline. This display pipeline includes dedicated hardware, programmable software components, shaders, and/or other components that perform projection, cropping, rotating, stitching, blending, and/or other operations that combine various camera views into a frame to be displayed to the driver. For example, multiple input channels (“windows”) of images from different cameras may be controlled by corresponding guest virtual machines within the display pipeline. Each guest virtual machine may perform and/or control processing related to image data included in a corresponding window. A composition stage may combine the processed image data from the windows into a single frame, and a post-processing stage may generate a final output frame to be displayed on a screen. Because multiple stages of processing are needed to convert camera views into a frame for display, the time between image capture by the cameras and display of a frame that includes portions of the captured images may exceed the frame rate of the screen. Consequently, multiple frames may be “in progress” within the display pipeline to produce a continuous stream of frames for display on the screen.

An error in any part of this display pipeline may cause duplicate (e.g., frozen, delayed, repeated, etc.) frames to be displayed on the screen. Because these duplicate frames do not reflect the most up-to-date conditions around the vehicle, the driver may fail to notice pedestrians, vehicles, and/or other objects or obstacles in the vicinity of the vehicle. Thus, it is important to detect and alert the driver to the duplicate frames to avoid potential safety issues and/or accidents arising from stale, misleading, or unsafe image data in the displayed camera views.

Conventional approaches for detecting duplicate frames in a single automotive camera view with a fixed perspective involve dividing each frame of the camera view into multiple regions and computing a checksum (e.g., a Cyclic Redundancy Check (CRC)) for each of the regions. Each checksum is subsequently compared across frames by software, and repetitions of the frames are detected when the checksums computed for the same region in consecutive frames match one another. For example, each guest virtual machine may control a corresponding input channel that includes image data to be included in the frames. A host virtual machine with full access to the display hardware at the end of the display pipeline subsequently computes CRCs for regions of frames to be displayed on the screen and compares the computed CRCs with CRCs for the same regions in previous frames.

However, software-based verification of checksums for automotive camera views incurs significant latency and resource overhead, which can interfere with timely detection and notification of duplicate frames in the automotive camera views. Additionally, complicated communication between the guest virtual machine operating a given input channel and the host virtual machine verifying the checksums can result in synchronization issues because the host virtual machine may fail to match changes made by the guest virtual machine to a corresponding scan-out frame to be displayed on the screen.

As such, a need exists for more effective techniques for improving the detection of duplicate frames in camera views.

### SUMMARY

Embodiments of the present disclosure relate to end-to-end camera view verification for automotive systems and applications. The techniques described herein include computing a checksum for at least a portion of a frame to be displayed on a screen, where the frame includes one or more views captured using one or more cameras. The techniques also include receiving a sequence of checksums associated with one or more previous frames displayed on the screen. The techniques further include updating one or more counters based on one or more comparisons of the computed checksum and the sequence of checksums and causing an alert associated with display of the frame on the screen to be generated based on the one or more counters.

One technical advantage of the disclosed techniques relative to conventional solutions is the ability to detect both frozen frames and repeated frames that include camera views of an environment around a vehicle. Accordingly, the disclosed techniques are capable of detecting issues in the composition and post-composition processing stages of the display pipeline that occur right before the frames are displayed on the screen. Another technical advantage of the disclosed techniques is the ability to customize the detection and alert of frozen and repeated frames for different regions of the frames, display pipelines, image capture rates, display scan-out rates, and/or latencies and/or tolerances associated with duplicate frame detection. The disclosed techniques may thus be adapted to various use cases and/or conditions associated with duplicate frame detection in camera views and/or visualizations of an environment around a vehicle.

### BRIEF DESCRIPTION OF THE DRAWINGS

The present systems and methods for end-to-end camera view verification for automotive systems and applications are described in detail below with reference to the attached drawing figures, wherein:

FIG. 1 illustrates a computing device configured to implement one or more aspects of various embodiments;

FIG. 2 is a more detailed illustration of the virtual machine and display pipeline of FIG. 1, according to various embodiments;

FIG. 3 is a more detailed illustration of the checker of FIG. 2, according to various embodiments;

FIG. 4 illustrates a flow diagram of a method for verifying output frames associated with one or more camera views, according to various embodiments;

FIG. 5A is an illustration of an example autonomous vehicle, in accordance with some embodiments of the present disclosure;

FIG. 5B is an example of camera locations and fields of view for the example autonomous vehicle of FIG. 5A, in accordance with some embodiments of the present disclosure;

FIG. 5C is a block diagram of an example system architecture for the example autonomous vehicle of FIG. 5A, in accordance with some embodiments of the present disclosure;

FIG. 5D is a system diagram for communication between cloud-based server(s) and the example autonomous vehicle of FIG. 5A, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

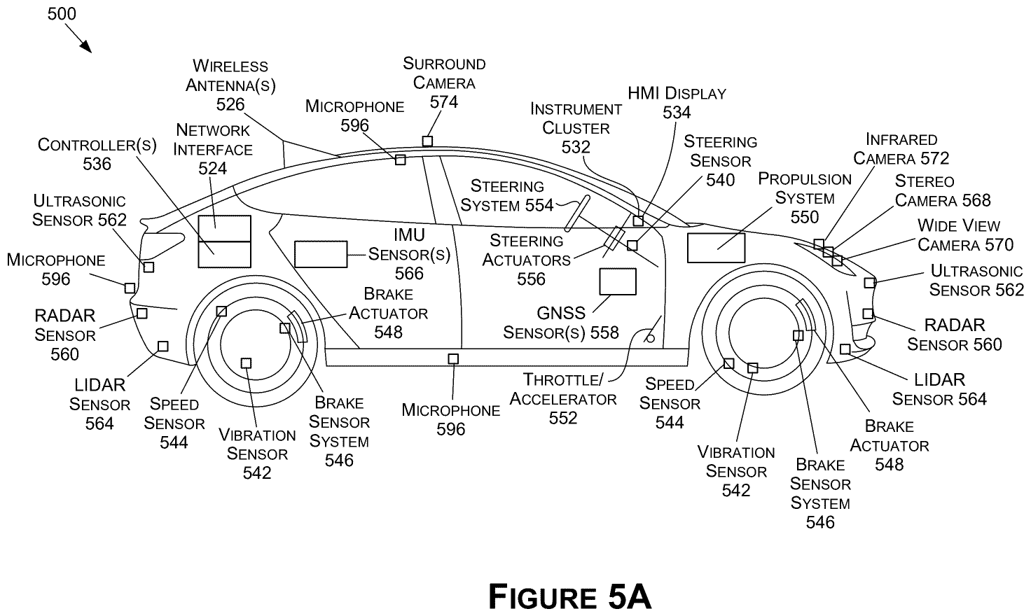

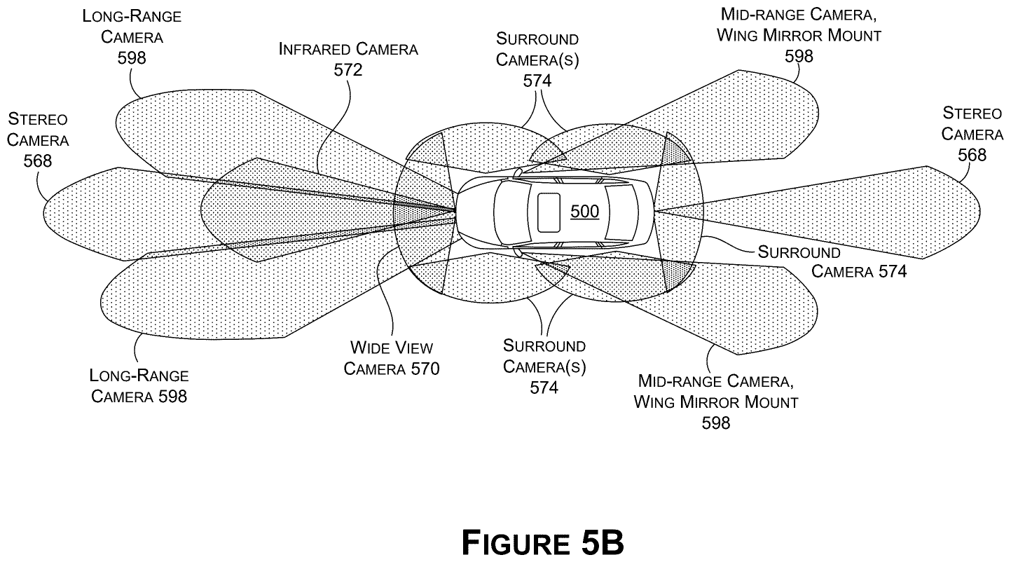

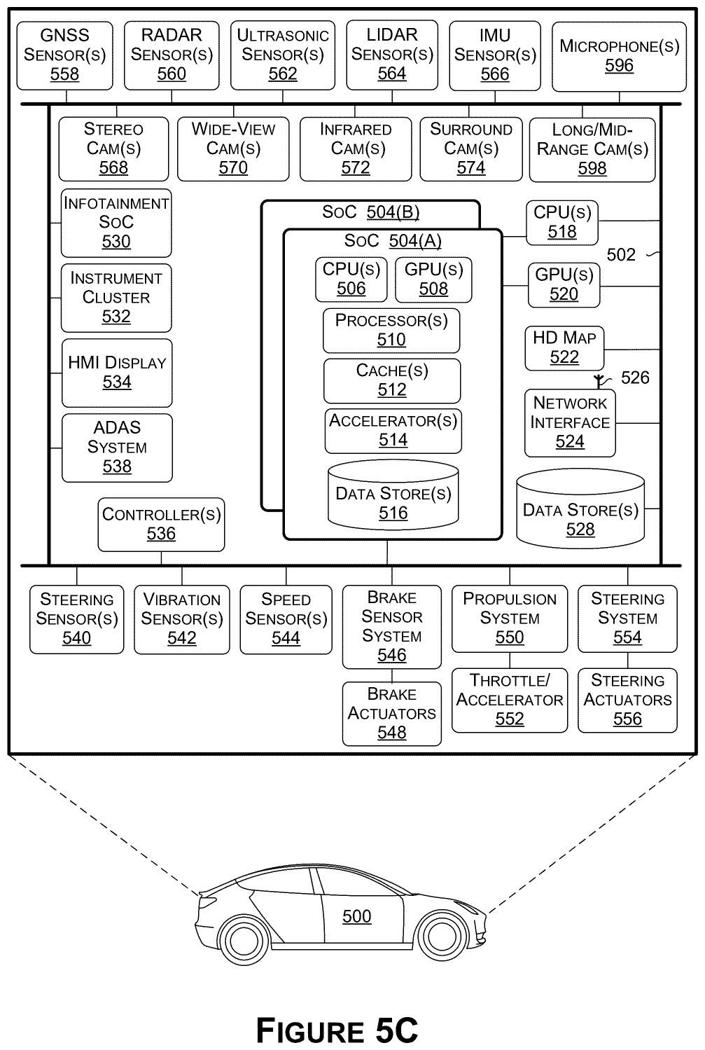

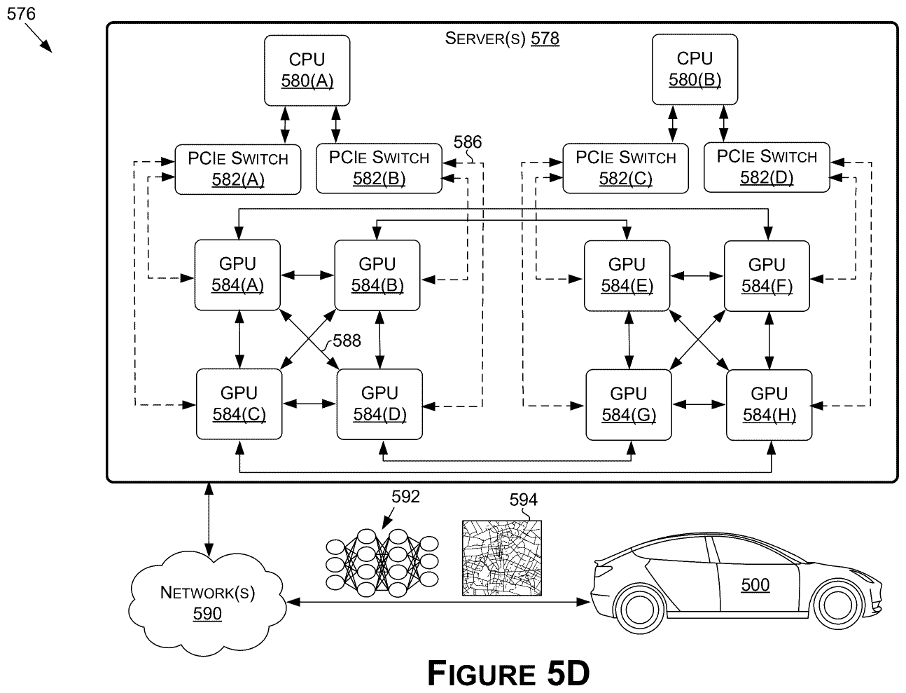

Systems and methods are disclosed related to end-to-end camera view verification for automotive systems and applications. Although the present disclosure may be described with respect to an example autonomous vehicle or semi-autonomous vehicle or machine 500 (alternatively referred to herein as “vehicle 500,” “ego-vehicle 500,” “machine 500,” or “ego-machine 500,” an example of which is described with respect to FIGS. 5A-5D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to end-to-end camera view verification for autonomous systems and applications, this is not intended to be limiting, and the systems and methods described herein may be used in augmented reality, virtual reality, mixed reality, robotics, security and surveillance, autonomous or semi-autonomous machine applications, and/or any other technology spaces where camera views may be used.

As discussed herein, conventional approaches for verifying checksums for automotive camera views incur significant latency and resource overhead, which can interfere with timely detection and notification of duplicate frames in the automotive camera views. Additionally, complicated communication between a guest virtual machine operating a given input (e.g., window) channel and a host virtual machine performing the checksum verifications can result in synchronization issues because the host virtual machine may fail to match changes made by the guest virtual machine to a corresponding scan-out frame to be displayed on the screen.

To improve the detection of duplicate frames in camera views that are included in visualizations, the disclosed techniques allow a guest virtual machine operating an input channel to specify settings that can be used to detect duplicate frames that include camera views to be displayed on a screen. These settings may include (but are not limited to) a full-screen or partial-screen surface (image) that includes one or more regions to be verified, positions and sizes of the region(s) after image data from multiple input channels has been composed into the frame, settings to enable hardware checksum verification of the region(s), a number of previous frames for which duplicate frame detection is to be performed, a limit to the number of frozen frames that can be detected within a given region, a limit to the number of repeated frames that can be detected within a given region, and/or one or more thresholds to be met before an error or alert related to frozen and/or repeated frames is generated. These settings are forwarded to display controller hardware that implements checker circuits for individual regions in the frames.

Each checker circuit computes a checksum for a corresponding region (or portion) of a frame and retrieves, from a buffer, a sequence of checksums associated with previous frames for which duplicate frame detection is to be performed. This sequence of checksums may include a length that matches the number of “in progress” frames within a display pipeline for the camera views. The sequence of checksums may also be ordered by time (e.g., from the most recent frame to the least recent frame). The checker circuit compares the computed checksum with each checksum in the sequence. When the computed checksum matches a checksum for the most recent frame displayed on the screen (e.g., the first checksum in the sequence), the checker circuit increments a frozen frame counter and resets a repeated frame counter. When the computed checksum matches a checksum for a previous frame that is older than the most recent frame (e.g., a checksum that follows the first checksum in the sequence), the checker circuit increments the repeated frame counter, resets the frozen frame counter, and moves the matched checksum to the front of the sequence. When the computed checksum does not match any of the checksums in the sequence, the checker circuit adds the computed checksum to the front of the sequence, drops the last checksum from the end of the sequence, and resets both counters.

Each checker circuit also compares the frozen frame counter with a frozen frame limit and compares the repeated frame counter with a repeated frame limit. When a given counter exceeds a corresponding limit, the checker circuit generates a corresponding alert (e.g., a frozen frame alert or a repeated frame alert) to a roll-up module included in the display controller HW. The roll-up module compares the number of reported frozen frame alerts and/or repeated frame alerts from the checkers with a corresponding threshold. When the threshold is met or exceeded, the display controller generates a corresponding error (e.g., a frozen frame error or a repeated frame error) in the display of camera views on the screen. The error may then be outputted to a driver, used to drop the frame, used to blank the screen, and/or used to perform another action to prevent the driver from operating the vehicle using stale, misleading, or less safe than desirable image data.

One technical advantage of the disclosed techniques relative to conventional solutions is the ability to detect both frozen frames and repeated frames that include camera views of an environment around a vehicle. Accordingly, the disclosed techniques are capable of detecting issues in the composition and post-composition processing stages of the display pipeline that occur right before the frames are displayed on the screen. Another technical advantage of the disclosed techniques is the ability to customize the detection and alert of frozen and repeated frames for different regions of the frames, display pipelines, image capture rates, display scan-out rates, and/or latencies and/or tolerances associated with duplicate frame detection. The disclosed techniques may thus be adapted to various use cases and/or conditions associated with duplicate frame detection in camera views and/or visualizations of an environment around a vehicle.

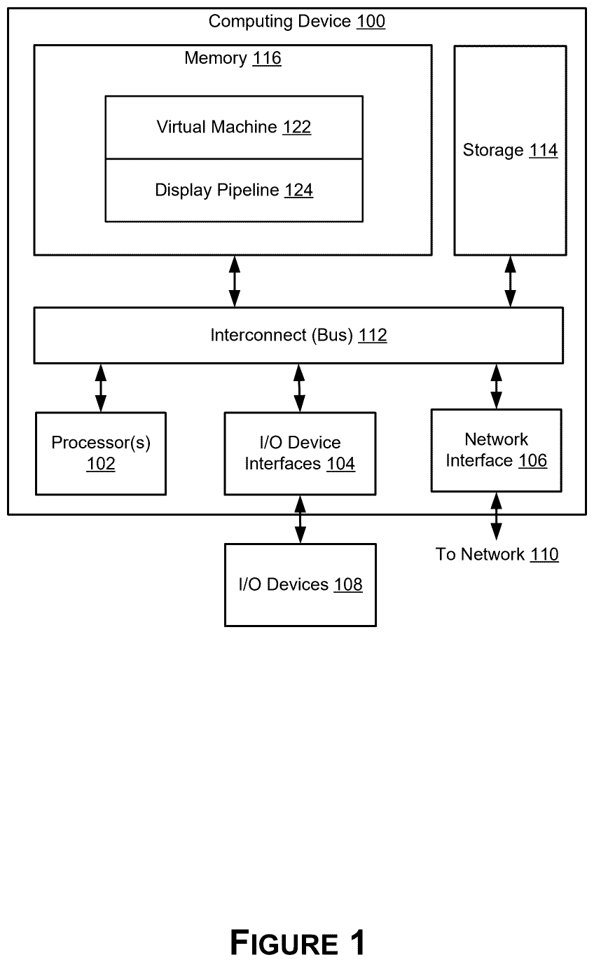

FIG. 1 illustrates a computing device 100 configured to implement one or more aspects of various embodiments. In at least one embodiment, computing device 100 includes a desktop computer, a laptop computer, a smart phone, a personal digital assistant (PDA), a tablet computer, a server, one or more virtual machines, an embedded system, a system(s) on a chip(s), an in-vehicle computing device, and/or any other type of computing device configured to receive input, process data, and optionally display images, and is suitable for practicing one or more embodiments. Computing device 100 is configured to run a virtual machine 122 and a display pipeline 124 that may reside in a memory 116.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and/or a network interface 106. Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a parallel processing unit (PPU), a data processing unit (DPU), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing device 100 may correspond to a physical computing system (e.g., a system in a data center) and/or may correspond to a virtual computing instance executing within a computing cloud.

In at least one embodiment, I/O devices 108 include devices capable of receiving input, such as a keyboard, a mouse, a touch screen, a touchpad, a VR/MR/AR headset, a gesture recognition system, and/or a microphone, as well as devices capable of providing output, such as a display device(s), a haptic device(s), and/or a speaker(s). Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In one embodiment, network 110 is any technically feasible type of communications network that allows data to be exchanged between computing device 100 and internal, local, remote, or external entities or devices, such as a web server or another networked computing device. For example, network 110 may include a wide area network (WAN), a local area network (LAN), a wireless (e.g., WiFi) network, a cellular network, and/or the Internet, among others.

In at least one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Virtual machine 122 and/or display pipeline 124 may be stored in storage 114 and loaded into memory 116 when executed.

In one embodiment, memory 116 includes a random-access memory (RAM) module, a flash memory unit, and/or any other type of memory unit or combination thereof. Processor(s) 102, I/O device interface 104, and network interface 106 may be configured to read data from and write data to memory 116. Memory 116 may include various software programs that can be executed by processor(s) 102 and application data associated with said software programs, including virtual machine 122 and display pipeline 124.

Virtual machine 122 includes functionality to coordinate and control the processing of image data within an input channel. The input channel may correspond to an independent source (e.g., “window”) of image data that can be used to generate a frame for output on a display. This image data may include frames and/or portions of frames captured by a set of cameras. The cameras may capture multiple views of an environment around a vehicle, robotic system, surveillance system, or another type of system that includes computing device 100.

More specifically, virtual machine 122 is configured to execute a control flow that sets up and controls the execution of various components within a corresponding display pipeline 124 for the input channel. As described in further detail below, these components may perform image capture, projection, cropping, scaling, color adjustment, rotating, stitching, blending, rasterizing, rendering, composition, and/or other operations to convert image data within the input channel into a form that can be outputted on a display and/or otherwise used by the system that includes computing device 100.

Additionally, multiple instances of virtual machine 122 and display pipeline 124 may execute on one or more instances of computing device 100, a distributed system, and/or a cloud computing system to control the processing of image data from multiple corresponding input channels into an output frame representing a visualization of the environment surrounding the system. For example, instances of virtual machine 122 and display pipeline 124 may operate to combine multiple “windows” of image data that depict different camera views of the environment into an output frame representing a two-dimensional (2D) and/or three-dimensional (3D) visualization, top-down visualization, multi-viewport visualization, and/or other view of the environment. The output frame may then be displayed on one or more screens in a vehicle, computer system, and/or another system that includes one or more instances of computing device 100.

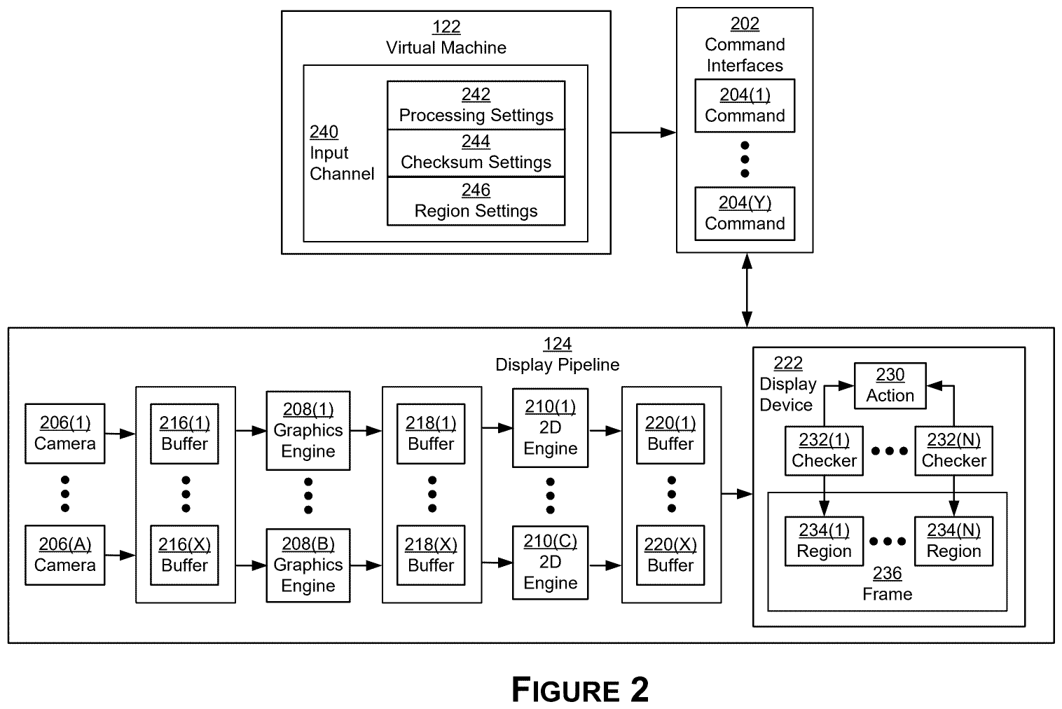

FIG. 2 is a more detailed illustration of virtual machine 122 and display pipeline 124 of FIG. 1, according to various embodiments. As discussed herein, virtual machine 122 configures and controls the operation of multiple components in display pipeline 124 to convert image data collected by a set of cameras 206(1)-206(A) (each of which is referred to individually herein as camera 206) into a frame 236 that can be displayed on a display device 222. These components include a set of graphics engines 208(1)-208(B) (each of which is referred to individually herein as graphics engine 208), a set of two-dimensional (2D) engines 210(1)-210(C) (each of which is referred to individually herein as 2D engine 210), display device 222, a set of buffers 216(1)-216(X) (each of which is referred to individually herein as buffer 216) between cameras 206 and graphics engines 208, a set of buffers 218(1)-218(X) (each of which is referred to individually herein as buffer 218) between graphics engine 208 and 2D engines 210, and a set of buffers 220(1)-220(X) (each of which is referred to individually herein as buffer 220) between 2D engines 210 and display device 222. Each of these components is described in further detail below.

Cameras 206 include image sensors, lenses, actuators, controllers, and/or other hardware and/or software components for capturing visible light, infrared light, depth information, and/or another view of an environment. For example, each camera 206 may generate a sequence of video frames at a certain rate. Each camera 206 may also, or instead, generate images and/or video frames that depict an area in front of, behind, to the side of, below, and/or above a vehicle or another system in which display pipeline 124 is deployed.

Although described primarily with respect to cameras (or image sensors) generating image/video frames, this is not intended to be limiting, and in some embodiments additional or alternative sensor modalities may be used without departing from the scope of the present disclosure. For example, sensor data representations (e.g., point clouds, projection images, range images, etc.) generated using LiDAR sensors, RADAR sensors, ultrasonic sensors, depth sensors, stereo cameras, etc. may be used in addition to or in lieu of image data from cameras 206.

Images, video frames, and/or other raw image data captured by cameras 206 are stored in buffers 216 and subsequently read by one or more graphics engines 208. Each graphics engine 208 converts at least a portion of the raw image data into intermediate graphical output in a 2D or three-dimensional (3D) space. For example, one or more graphics engines 208 may perform projection, scaling, rotation, shear mapping, stitching, rendering, compositing, and/or other operations on the raw image data to stitch raw image data from two or more cameras 206 into a single image, adjust the point of view associated with image data from one or more cameras 206, generate a 3D model of one or more portions of the environment around the system, and/or otherwise convert pixel values captured by cameras 206 into the intermediate graphical output.

Graphics engines 208 also store intermediate graphical output in buffers 216 for subsequent consumption by one or more 2D engines 210. Each 2D engine 210 performs additional processing on the intermediate graphical output to generate one or more portions of frame 236 for display by display device 222. For example, each 2D engine 210 may perform scaling, color adjustment, blending, rasterizing, and/or other operations to further refine and/or adjust the intermediate graphical output and/or convert the intermediate graphical output into pixel values that are suitable for display by display device 222.

Pixel values outputted by 2D engines 210 are stored in a set of buffers 220 for subsequent consumption by display device 222. Display device 222 retrieves these pixel values from buffers 220 and performs a final composition of the data into frame 236. For example, display device 222 may compose and/or layer pixel values from multiple buffers 220, multiple instances of display pipeline 124, and/or multiple input channels corresponding to individual instances of display pipeline 124 into a single frame 236 to be displayed on a screen. After generation of frame 236 is complete, display device 222 displays this frame 236 on the screen. Display device 222 additionally updates the displayed frame 236 using new pixel values from buffers 220 according to a configurable frequency. For example, display device 222 may output frames on the screen at a frequency of around 60 Hz, while cameras 206 may capture image at a frequency of around 30 Hz. Thus, display device 222 may display a given frame 236 twice before generating a new frame 236 using new pixel values from buffers 220.

In one or more embodiments, virtual machine 122 includes applications, processes, services, user mode drivers, kernel mode drivers, and/or other components. Components within virtual machine 122 are executed in a manner that is isolated from underlying hardware and/or other virtual machines (e.g., additional instances of virtual machine 122, other types of virtual machines, etc.) on the same computing device (e.g., computing device 100 of FIG. 1). For example, virtual machine 122 and/or other virtual machines executing on the computing device may access hardware resources on the computing device via a type I hypervisor that runs directly on one or more processors in the computing device or a type II hypervisor that runs as a software layer on a host operating system executing on the computing device. The hypervisor may additionally enable or disable individual virtual machines and/or individual instances of virtual machine 122, connect one or more virtual machines and/or instances of virtual machine 122 to a given display pipeline 124 and/or display device 222, and/or otherwise configure the arrangement of virtual machines, display pipelines, and/or other components associated with displaying output frames within a given system.

As shown in FIG. 2, virtual machine 122 orchestrates the operation of various components (e.g., cameras 206, graphics engine 208, 2D engines 210, display device 212, etc.) in display pipeline 124 by transmitting and/or storing commands 204(1)-204(Y) (each of which is referred to individually herein as command 204) using one or more command interfaces 202 with these components. Each of command interfaces 202 may allow virtual machine 122 to communicate with a corresponding component (or type of component) in display pipeline 124. For example, each of command interfaces 202 may include one or more command buffers, registers, and/or other locations into which virtual machine 122 writes commands 204. These commands 204 may include (but are not limited to) processing settings 242 that configure the capture of images by cameras 206, processing of image data by graphics engines 208 and 2D engines 210, and composition and/or display of the image data by display device 222.

In some embodiments, the value of X denoting the number of buffers in each set of buffers 216(1)-216(X), 218(1)-218(X), and 220(1)-220(X) is set to the depth of display pipeline 124 (e.g., the number of stages in display pipeline 124). As new images are captured by cameras 206 and/or user input related to a visualization represented by frames outputted on display device 222 (e.g., input to zoom in or out of the visualization, rotate the visualization, and/or otherwise change the view or perspective associated with the visualization) is received, virtual machine 122 may write new commands 204 to command interfaces 202 in a way that causes cameras 206, graphics engines 208, 2D engines 210, and/or display device 222 to cycle through the corresponding sets of buffers 216, 218, and 220 (e.g., similar to a rolling buffer). These commands 204 may cause cameras 206, graphics engines 208, 2D engines 210, and/or display device 222 to capture and/or process image data in a way that reflects the latest camera 206 views of the environment around the system and/or the latest user input related to the view or perspective associated with a visualization of the environment.

For example, virtual machine 122 may transmit commands 204 over command interfaces 202 to cameras 206, graphics engine 208, 2D engines 210, and display device 222 in a way that is flip-synchronized with the rate at which frames are outputted on display device 222 and/or captured by cameras 206. During this flip synchronization, virtual machine 122 may transmit commands 204 that instruct each camera 206 to switch buffers 216 to which captured image data is written, so that consecutive images captured by that camera 206 are written to different buffers 216 and the newest image captured by the camera 206 is written to a given buffer 216 that previously stored the oldest image captured by that camera 206. Virtual machine 122 may also, or instead, transmit commands 204 that instruct each graphics engine 208 to switch from reading older image data from one or more buffers 216 to reading newer image data from one or more other buffers 216 and/or write the most recent set of intermediate graphical output to one or more buffers 218 in which the oldest intermediate graphical output was stored. Virtual machine 122 may also, or instead, transmit commands 204 that instruct each 2D engine 210 to switch from reading older intermediate graphical output from one or more buffers 218 to reading newer intermediate graphical output from one or more other buffers 218 and/or write the most recent set of pixel values generated from the intermediate graphical output to one or more buffers 220 in which the oldest pixel values were stored. These commands 204 to graphics engines 208 and/or 2D engines 210 may additionally instruct each graphics engine 208 and/or 2D engine 210 to generate intermediate graphical output and/or pixel values in a way that reflects the latest zoom levels, rotations, and/or other transformations to the visualization specified in the user input. Virtual machine 122 may also, or instead, transmit commands 204 that instruct display device 222 to switch from reading older pixel values from one or more buffers 220 to reading newer pixel values from one or more other buffers 220.

Because display pipeline 124 includes multiple components, sets of buffers 216, 218, and 220, and stages of processing, errors at any component and/or stage may cause display device 222 to output duplicate (e.g., frozen, delayed, repeated, etc.) frame 236 content. If this duplicate frame 236 content is not detected and addressed, a user of the system may operate the system and/or make decisions using stale, misleading, or less safe than desirable image data on display device 222. For example, a driver of a vehicle that includes virtual machine 122 and display pipeline 124 may attempt to drive and/or park the vehicle using a visualization of the environment around the vehicle that is outputted on display device 222. When the visualization includes duplicate frame 236 content that does not reflect the most up-to-date conditions around the vehicle, the driver may fail to notice pedestrians, vehicles, and/or other objects or obstacles in the vicinity of the vehicle.

In one or more embodiments, virtual machine 122 and display device 222 operate to detect and manage duplicate (e.g., frozen, delayed, repeated, etc.) frames that are generated by display pipeline 124 for output on display device 222. As shown in FIG. 2, virtual machine 122 writes commands 204 that include checksum settings 244 and region settings 246 to one or more command interfaces 202 associated with display device 222. Display device 222 includes a number of checkers 232(1)-232(N) (each of which is referred to individually herein as checker 232) that use checksum settings 244 and region settings 246 to compare checksums associated with various regions 234(1)-234(N) (each of which is referred to individually herein as region 234) within a given frame 236 to checksums for corresponding regions 234 in previous frames outputted on display device 222. These checkers 232 may be implemented using dedicated circuits, microcontrollers, and/or other hardware components on display device 222.

As used herein, a checksum refers to a data element that is derived from another block of data for the purpose of detecting errors or changes to the block of data during storage or transmission. A checksum may be computed using CRCs, hash functions, parity checks, Fletcher checksums, Adler checksums, and/or other techniques for converting a block of data into values that can be used to “check” or verify the integrity of the block of data.

In some embodiments, checksum settings 244 are used to configure the verification of checksums for various regions 234 in a given frame 236 by checkers 232 in display device 222. For example, checksum settings 244 may include (but are not limited to) a type of checksum to compute for each region 234 in a given frame 236, the number of checksums to compute for a given frame 236, the number of checksums for previous frames to which a computed checksum is to be compared, rules for updating the sequence of checksums for previous frames based on the most recently computed checksums, rules for tracking repetitions in checksums across frames, rules for generating alerts based on comparisons of the computed checksums with checksums for previous frames, and/or other settings related to using checksums for regions 234 to detect and/or manage duplicate frames by display device 222.

Region settings 246 define regions 234 within a given frame 236 for which checksums are to be verified. For example, region settings 246 may include (but are not limited to) positions, dimensions, bounding boxes, and/or other representations of boundaries for each region 234; flags to enable and/or disable a given checker 232 and/or corresponding region 234; locations (e.g., addresses and/or buffers 220) in which image data for a given region 234 is stored; a total number of regions 234 for which checksums are to be verified; and/or other settings related to defining regions 234 for which duplicate content is to be detected. As content in each frame 236 is updated to reflect the latest camera 206 views of the environment around the system and/or user input that specifies changes to the view or perspective associated with the visualization shown on screen by display device 222, region settings 246 may also be updated to identify regions 234 within each frame 236 that correspond to camera views that should vary over time.

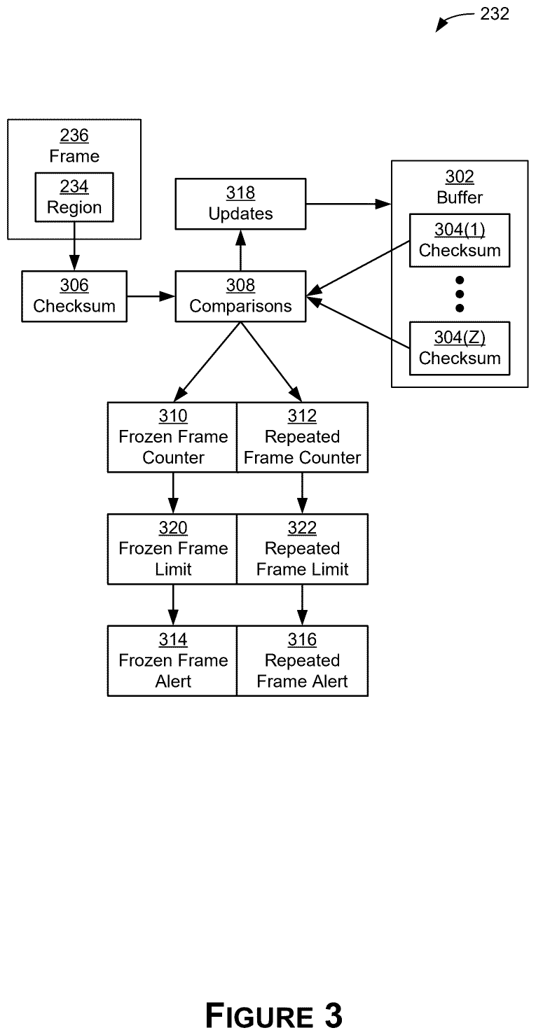

In some embodiments, each checker 232 in display device 222 detects duplicate content in a corresponding region 234 of a given frame 236 to be shown on screen by display device 222 by retrieving one or more commands 204 from one or more command interfaces 202 with virtual machine 122. Each checker 232 uses region settings 246 specified in the retrieved commands 204 to obtain pixel values within that region 234. Each checker 232 also uses checksum settings 244 specified in the retrieved commands 204 to compute a checksum for the pixel values within the region 234 and compare the computed checksum with checksums for the same region 234 in one or more previous frames. Each checker 232 further generates alerts and/or other output based on the results of the comparison. The operation of checkers 232 is described in further detail below with respect to FIG. 3.

FIG. 3 is a more detailed illustration of checker 232 of FIG. 2, according to various embodiments. As shown in FIG. 3, checker 232 computes a checksum 306 (e.g., a cyclic redundancy check (CRC)) for a corresponding region 234 of a given frame 236 to be displayed on display device 222. For example, checker 232 may use region settings 246 and/or checksum settings 244 received from virtual machine 122 to retrieve pixel values included in region 234 from one or more locations in memory and compute checksum 306 from the pixel values.

Checker 232 performs comparisons 308 of checksum 306 with a sequence of checksums 304(1)-304(Z) (each of which is referred to individually as checksum 304) stored in a buffer 302. For example, checker 232 may determine whether or not checksum 306 matches any checksums 304 in buffer 302. In some embodiments, buffer 302 stores checksums 304 computed for a set of regions within a certain number of previous frames received for output by display device 222. This set of regions and region 234 may include pixel values that correspond to views captured by the same camera 206 and/or views of the same portion of the environment depicted in the frames.

Within buffer 302, checksums 304 may be ordered by descending recency. For example, the first checksum 304 in buffer 302 may correspond to the most recent previous frame, and the last checksum 304 in buffer 302 may correspond to a previous frame that is Z-1 frames older than the most recent previous frame. In another example, buffer 302 may store Z unique checksums 304 for Z consecutive and/or non-consecutive previous frames (e.g., frames that are fixed and/or variable numbers of positions apart from one another). The number of checksums 304 stored in buffer 302 (e.g., the value of Z), the spacing of frames associated with checksums 304 stored in buffer 302, and/or other parameters related to checksums 304 for previous frames in buffer 302 may be specified in one or more checksum settings 244 from virtual machine 122. For example, virtual machine 122 may transmit, to checker 232, checksum settings 244 that set the number of checksums 304 in buffer 302 equal to or greater than the number of stages in display pipeline 124, the number of buffers 216, 218, and/or 220 between consecutive stages of display pipeline 124, the number of “in progress” frames within display pipeline 124, and/or another value that reflects the structure and/or operation of display pipeline 124.

Checker 232 additionally updates a frozen frame counter 310 and/or a repeated frame counter 312 based on the results of comparisons 308. Frozen frame counter 310 tracks the number of consecutive times over which the same frame is received for output by display device 222. For example, frozen frame counter 310 may be used to detect a frozen frame condition, in which display device 222 continues to show the same frame 236 over a period that is greater than the time between consecutive frames captured by cameras 206. This frozen frame condition may be caused by a lack of new frames in buffers 220 read by display device 222, a lack of change in buffers 220 read by display device 222, and/or another factor that interferes with the ability of display device 222 to receive the latest frame 236. This frozen frame condition may result in the appearance of a static image on a screen that is driven by display device 222.

Repeated frame counter 312 tracks the number of non-consecutive times over which the same frame is received for output by display device 222. For example, repeated frame counter 312 may be used to detect a repeated frame condition, in which a frame that was shown earlier but not most recently is subsequently received for output by display device 222 due to an inability to properly update buffers 220 storing the earlier-shown frame with newer frame data. This repeated frame condition may result in the continuous display of a repeating sequence of two or more frames by display device 222.

When the computed checksum 306 for region 234 matches a corresponding checksum 304 for the most recent frame displayed on the screen (e.g., the first checksum 304 in buffer 302), checker 232 increments frozen frame counter 310. When the computed checksum 306 matches a corresponding checksum 304 for a previous frame that is older than the most recent frame (e.g., a given checksum 304 that is not first in buffer 302), checker 232 increments repeated frame counter 312 and resets frozen frame counter 310. When the computed checksum 306 does not match any checksums 304 in buffer, checker 232 resets both frozen frame counter 310 and repeated frame counter 312.

Checker 232 additionally makes updates 318 to the sequence of checksums 304 in buffer 302 based on the results of comparisons 308. When the computed checksum 306 matches a corresponding checksum 304 for a previous frame that is older than the most recent frame, checker 232 reorders checksums 304 in buffer 302 so that the matching checksum 304 is moved to the front of buffer 302 and thereby represents the most recent frame. When the computed checksum 306 does not match any checksums 304 in buffer 302, checker 232 adds the computed checksum 306 to the front of buffer 302 and drops the last checksum 304 from the end of buffer 302. When the computed checksum 306 for region 234 matches a corresponding checksum 304 for the most recent frame displayed on the screen, checker 232 is not required to update buffer 302, as the sequence of checksums 304 in buffer 302 reflects the Z most recent unique checksums for frames to be outputted by display device 222 ordered by descending recency.

After updating frozen frame counter 310 and repeated frame counter 312, checker 232 compares frozen frame counter 310 with a frozen frame limit 320 and compares repeated frame counter 312 with a repeated frame limit 322. Frozen frame limit 320 and repeated frame limit 322 correspond to configurable thresholds and/or maximum values for frozen frame counter 310 and repeated frame counter 312, respectively. Frozen frame limit 320 and repeated frame limit 322 may also be specified in commands 204 from virtual machine 122, configurations associated with checker 232 and/or display pipeline 124, and/or another source. For example, frozen frame limit 320 and repeated frame limit 322 may be set and/or adjusted based on user preferences; safety requirements and/or levels associated with the system in which checker 232 is deployed; historical data associated with safe or unsafe operation of the system in the presence of a certain number of frozen frames and/or repeated frames; and/or other factors.

When frozen frame counter 310 exceeds frozen frame limit 320, checker 232 generates a frozen frame alert 314 for region 234. When repeated frame counter 312 exceeds repeated frame limit 322, checker 232 generates a repeated frame alert 316 for region 234. As discussed in further detail below, frozen frame alert 314 and/or repeated frame alert 316 may be used by display device 222 to detect and/or manage duplicate frames to be outputted on screen by display device 222.

Returning to the discussion of FIG. 2, display device 222 combines the results of checksum comparisons performed by all checkers 232 for a given frame 236 into an action 230 that is performed with respect to that frame 236 and/or subsequent frames. For example, display device 222 may include a roll-up module (not shown) that receives frozen frame alerts and/or repeated frame alerts from checkers 232 for frame 236. The roll-up module may compare the number of frozen frame alerts and/or repeated frame alerts from checkers 232 with a corresponding threshold. If the threshold is met or exceeded, display device 222 may generate an alert and/or notification of a corresponding error (e.g., a frozen frame error or a repeated frame error). The alert and/or notification may then be outputted on the screen to a driver in lieu of or in addition to frame 236 (e.g., as a visual overlay, speech output, tactile output, etc.), used to drop frame 236 and/or subsequent frames, used to blank the screen, used to trigger an action to remedy the duplicate frame condition by a safety monitor implemented in hardware and/or software, and/or used to perform another action 230 to prevent the driver from operating the vehicle using stale, misleading, or less safe than desirable image data. If the threshold is not met or exceeded, display device 222 may cause frame 236 and/or subsequent frames to be outputted on the screen.

The roll-up module may also, or instead, apply a set of rules and/or thresholds to frozen frame counters and/or repeated frame counters from checkers 232 to determine the corresponding action 230 to perform. These rules may indicate that frame 236 is to be outputted on a screen when all frozen frame counters and/or repeated frame counters associated with regions 234 in frame 236 are set to 0, the number of repeated frame counters and/or frozen frame counters with nonzero values falls below a threshold, all frozen frame counters and/or repeated frame counters have values that fall below a threshold, and/or another condition is met. These rules may also, or instead, indicate that frame 236 and/or subsequent frames are to be dropped, the screen is to be blanked, an alert indicating that the screen may include stale content is to be outputted, an action to remedy the duplicate frame condition is to be performed by a hardware and/or software safety monitor, and/or another action 230 related to the management of duplicate content in frame 236 is to be performed when the number of frozen frame counters and/or repeated frame counters with nonzero values is greater than a threshold, at least one frozen frame counter and/or repeated frame counter has a value that exceeds a threshold, and/or another condition is met.

The roll-up module may also, or instead, use time series analysis and/or machine learning techniques to determine action 230 based on frozen frame counters, frozen frame alerts, repeated frame counters, repeated frame alerts, results of checksum comparisons, and/or other data from checkers 232. These techniques may indicate that frame 236 is to be outputted on a screen when a sequence of the N most recent frozen frame counters, frozen frame alerts, repeated frame counters, repeated frame alerts, results of checksum comparisons, and/or other data from checkers 232 is associated with less than a threshold likelihood of a certain type of safety issue and/or another outcome. These techniques may also, or instead, indicate that frame 236 is to be dropped, the screen is to be blanked, an alert indicating that the screen may include stale content is to be outputted, and/or another action 230 related to the management of duplicate content in frame 236 is to be performed when the sequence is associated with at least the threshold likelihood of the outcome.

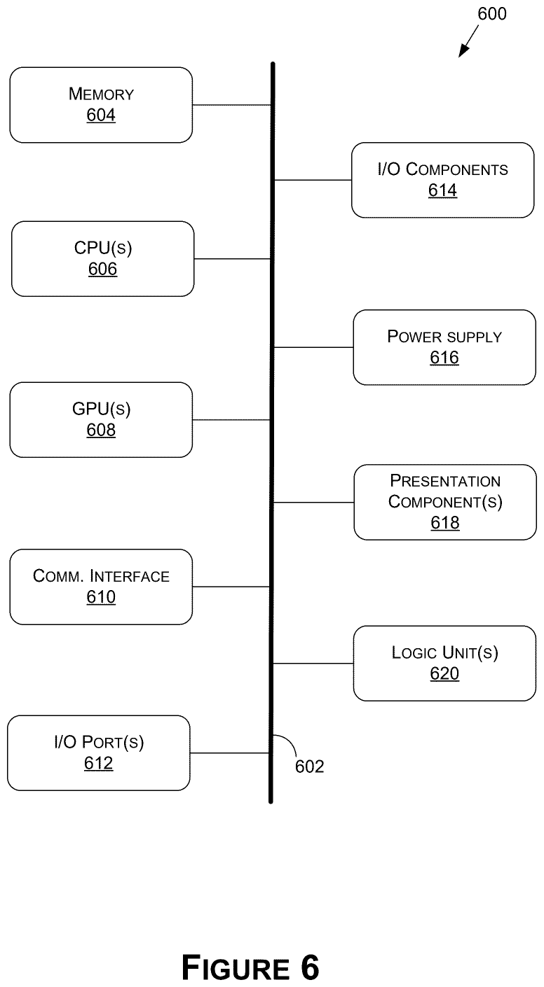

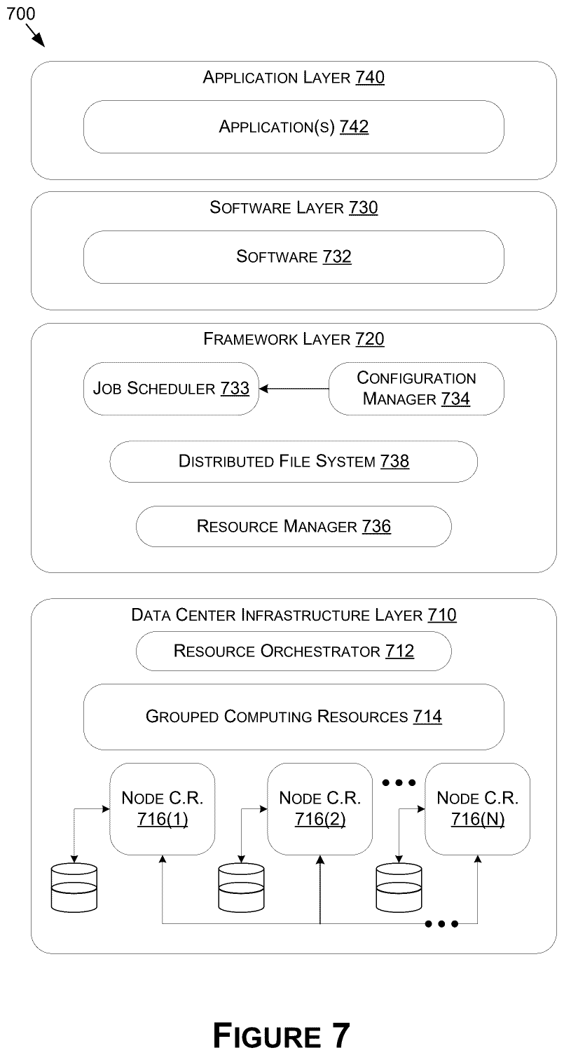

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 500 of FIGS. 5A-5D, example computing device 600 of FIG. 6, and/or example data center 700 of FIG. 7.

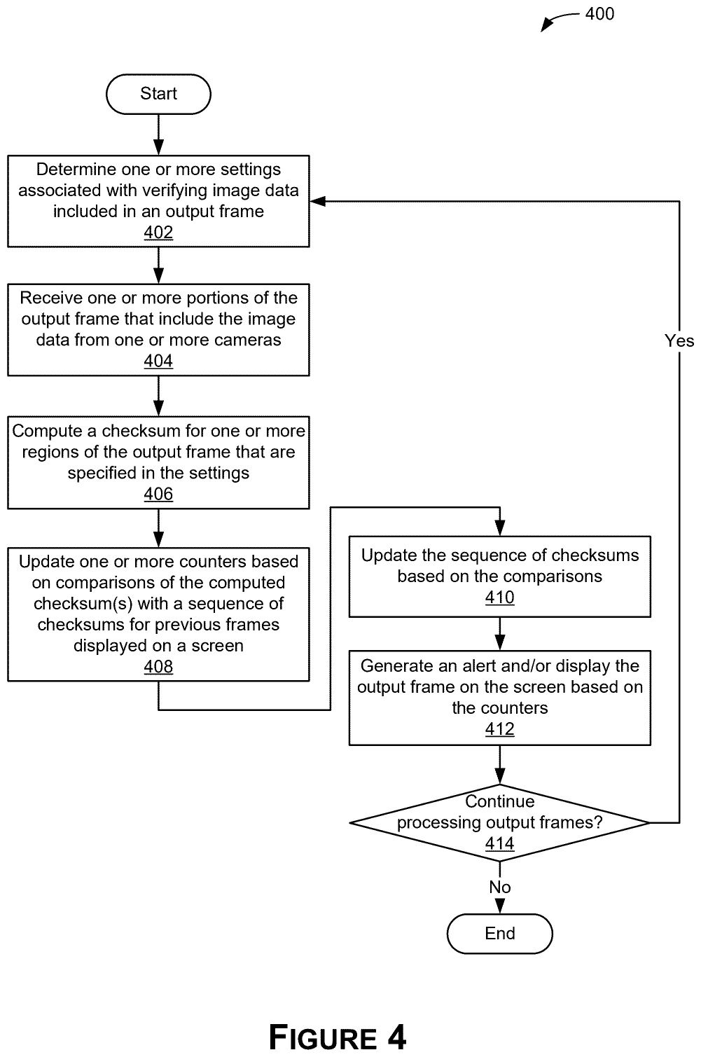

Now referring to FIG. 4, each block of method 400, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 400 is described, by way of example, with respect to the system of FIGS. 1-3. However, these methods may additionally or alternatively be executed by any one system, or any combination of systems, including, but not limited to, those described herein.

FIG. 4 illustrates a flow diagram of a method 400 for verifying output frames associated with one or more camera views, according to various embodiment. As shown in FIG. 4, method 400 begins with operation 402, in which display device 222 determines one or more settings associated with verifying image data included in an output frame 236. For example, display device 222 may receive the settings in the form of one or more commands from virtual machine 122. These commands may be received via one or more command interfaces, command buffers, registers, and/or other sources. The settings may define rectangular and/or other types of regions (or portions) of the output frame 236 to be verified, a type of checksum to compute for each region of the output frame 236, the number of checksums to compute for the output frame 236, the number of checksums for previous frames to which a computed checksum is to be compared, rules for updating the sequence of checksums for previous frames based on the most recently computed checksums, rules for tracking repetitions in checksums across frames, rules for generating alerts based on comparisons of the computed checksums with checksums for previous frames, and/or other settings related to using checksums for regions 234 to detect and/or manage duplicate frames by display device 222.

In operation 404, display device 222 receives one or more portions of the output frame 236 that include the image data from one or more cameras. For example, display device 222 may read the image data from one or more buffers 220 included in one or more instances of display pipeline 124. Each buffer 220 read by display device 222 and/or each input channel represented by a corresponding instance of display pipeline 124 may store at least a subset of pixel values to be included in the output frame.

In operation 406, display device 222 computes a checksum for one or more regions 234 of the output frame 236 that are specified in the settings. Continuing with the above example, display device 222 may composite, layer, and/or otherwise combine the image data from multiple buffers and/or input channels into the output frame 236. Display device 222 may then extract one or more regions of the output frame 236 specified in the settings and compute a checksum from pixel values in each region 234.

In operation 408, display device 222 updates one or more counters based on comparisons of the computed checksum(s) with a sequence of checksums for previous frames displayed on a screen. For example, display device 222 may include a separate checker 232 circuit for each region 234 to be verified. Each checker 232 may retrieve, from buffer 302, a sequence of checksums for regions in previous frames that were received for output by display device 222. The sequence of checksums may be ordered from the most recent frame to the least recent frame. Each checker 232 may compare the computed checksum for the output frame to each checksum in the sequence to determine whether or not the computed checksum matches any of the checksums in the sequence. If a given checker 232 determines that the checksum computed for a corresponding region 234 of the output frame 236 matches the first checksum in the sequence, that checker 232 may increment frozen frame counter 310. If a given checker 232 determines that the checksum computed for a corresponding region 234 of the output frame 236 matches a checksum in the sequence that is not the first checksum, that checker 232 may increment repeated frame counter 312 and reset frozen frame counter 310. If a given checker 232 determines that the checksum computed for a corresponding region of the output frame 236 does not match any of the checksums in the sequence, that checker 232 may reset both counters.

In operation 410, display device 222 updates the sequence of checksums based on the comparisons. Continuing with the above example, if a given checker 232 determines that the checksum computed for a corresponding region 234 of the output frame 236 matches a checksum in the sequence that is not the first checksum, that checker 232 may reorder the sequence so that the matching checksum is at the front of the sequence. If a given checker 232 determines that the checksum computed for a corresponding region 234 of the output frame 236 does not match any of the checksums in the sequence, that checker 232 may add the computed checksum to the sequence and drop the last (e.g., oldest) checksum from the sequence. If a given checker determines that the checksum computed for a corresponding region 234 of the output frame 236 matches the first checksum in the sequence, that checker 232 may keep the sequence of checksums as-is.

In operation 412, display device 222 generates an alert and/or displays the output frame 236 on the screen based on the counters. Continuing with the above example, each checker 232 may compare frozen frame counter 310 and/or repeated frame counter 312 with a corresponding threshold. If a given counter exceeds the corresponding threshold, that checker 232 may output an alert and/or event indicating that the threshold has been exceeded. A roll-up module in display device 222 may compare the number of frozen frame alerts and/or repeated frame alerts from all checkers 232 for the output frame with a corresponding threshold. If the threshold is met or exceeded, a display controller in display device 222 may generate a corresponding error (e.g., a frozen frame error or a repeated frame error). The error may be outputted on the screen in lieu of or in addition to the output frame 236 (e.g., as an overlay, audio output, tactile output, etc.), used to drop the output frame 236, used to blank the screen, and/or used to perform another action 230 to prevent the user from operating a system that includes display device 222 and/or making decisions using stale, misleading, or less safe than desirable image data. If the threshold is not met or exceeded, display device 222 may cause the output frame 236 to be outputted on the screen.

In operation 414, display device 222 determines whether or not to continue processing output frames. For example, display device 222 may continue to process output frames while the output frames are generated for display on the screen and/or used in one or more visualizations that are outputted on display device 222. While display device 222 continues processing output frames, display device 222 repeats operations 402, 404, 406, 408, 410, and 412 for each output frame. Display device 222 may continue processing output frames in this manner until output frames that include image data from one or more cameras and/or input channels are no longer outputted on the display device.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more large language models (LLMs), one or more vision language models (VLMs), and/or one or more multi modal language models, systems for performing light transport simulation, systems for performing collaborative content creation for 3D assets, systems implemented at least partially using cloud computing resources, and/or other types of systems.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the High Definition (“HD”) map 522 of FIG. 5C), location data (e.g., the vehicle's 500 location, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, a visualization of the environment around the vehicle 500, etc.), and/or information about driving maneuvers the vehicle has made, is making, or will make (e.g., changing lanes now, taking exit 34B in two miles, etc.).

The vehicle 500 further includes a network interface 524 which may use one or more wireless antenna(s) 526 and/or modem(s) to communicate over one or more networks. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the cameras (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may be any number (including zero) of wide-view cameras 570 on the vehicle 500. In addition, any number of long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

Any number of stereo cameras 568 may also be included in a front-facing configuration. In at least one embodiment, one or more of stereo camera(s) 568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360 degree camera(s), and/or the like. Four example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

As described above, views and/or frames captured by various cameras can be combined via various transformations into output frames that represent top-down, 3D, multi-viewport, and/or other types of visualizations of the environment around the vehicle 500. A virtual machine may orchestrate the processing of image data from the cameras into the frames by a display pipeline. The virtual machine may also configure a display device (e.g., HMI display 534) to detect and manage duplicate image data in successive output frames using the techniques discussed herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C are illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500, and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 504 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 512 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high-dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surroundings at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 560 m (front) or 80 m (rear), and a field of view of up to 42 degrees (front) or 550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 500 m, with an accuracy of 2 cm-3 cm, and with support for a 500 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200 m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network which is trained and thus reduces the risk of false positives, as described herein.

The vehicle 500 may further include the infotainment SoC 530 (e.g., an in-vehicle infotainment system (IVI)). Although illustrated and described as a SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road-work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). In some embodiments, the outputted data includes one or more visualizations of an environment around a vehicle or system in which computing device 600 resides. These visualizations are generated via stitching, blending, or other types of transformations applied to image data by CPU(s) 606 and/or GPU(s) 608. Individual frames and/or regions of frames in the visualizations are verified prior to output on the display by tracking and comparing checksums for the frames and/or regions, as discussed herein.

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

In sum, the disclosed techniques allow a guest virtual machine operating an input channel to specify settings that can be used to detect duplicate frames that include camera views to be displayed on a screen. These settings may include (but are not limited to) a full-screen or partial-screen surface (image) that includes one or more regions to be verified, positions and sizes of the region(s) after image data from multiple input channels has been composed into the frame, settings to enable hardware checksum verification of the region(s), a number of previous frames for which duplicate frame detection is to be performed, a limit to the number of frozen frames that can be detected within a given region, a limit to the number repeated frames that can be detected within a given region, and/or one or more thresholds to be met before an error or alert related to frozen and/or repeated frames is generated. These settings are forwarded to display controller hardware that implements checker circuits for individual regions in the frames.

Each checker circuit computes a checksum for a corresponding region (or portion) of a frame and retrieves, from a buffer, a sequence of checksums associated with previous frames for which duplicate frame detection is to be performed. This sequence of checksums may include a length that matches the number of “in progress” frames within a display pipeline for the camera views. The sequence of checksums may also be ordered by time (e.g., from the most recent frame to the least recent frame). The checker circuit compares the computed checksum with each checksum in the sequence. When the computed checksum matches a checksum for the most recent frame displayed on the screen (e.g., the first checksum in the sequence), the checker circuit increments a frozen frame counter and resets a repeated frame counter. When the computed checksum matches a checksum for a previous frame that is older than the most recent frame (e.g., a checksum that follows the first checksum in the sequence), the checker circuit increments the repeated frame counter, resets the frozen frame counter, and moves the matched checksum to the front of the sequence. When the computed checksum does not match any of the checksums in the sequence, the checker circuit adds the computed checksum to the front of the sequence, drops the last checksum from the end of the sequence, and resets both counters.

Each checker circuit also compares the frozen frame counter with a frozen frame limit and compares the repeated frame counter with a repeated frame limit. When a given counter exceeds a corresponding limit, the checker circuit generates a corresponding alert (e.g., a frozen frame alert or a repeated frame alert) to a roll-up module included in the display controller HW. The roll-up module compares the number of reported frozen frame alerts and/or repeated frame alerts from the checkers with a corresponding threshold. When the threshold is met or exceeded, the display controller generates a corresponding error (e.g., a frozen frame error or a repeated frame error) in the display of camera views on the screen. The error may then be outputted to a driver, used to drop the frame, used to blank the screen, and/or used to perform another action to prevent the driver from operating the vehicle using stale, misleading, or less safe than desirable image data.

One technical advantage of the disclosed techniques relative to conventional solutions is the ability to detect both frozen frames and repeated frames that include camera views of an environment around a vehicle. Accordingly, the disclosed techniques are capable of detecting issues in the composition and post-composition processing stages of the display pipeline that occur right before the frames are displayed on the screen. Another technical advantage of the disclosed techniques is the ability to customize the detection and alert of frozen and repeated frames for different regions of the frames, display pipelines, image capture rates, display scan-out rates, and/or latencies and/or tolerances associated with duplicate frame detection. The disclosed techniques may thus be adapted to various use cases and/or conditions associated with duplicate frame detection in camera views and/or visualizations of an environment around a vehicle.

1. In some embodiments, a method comprises computing a checksum for at least a portion of a frame to be displayed on a screen, the frame including one or more views captured using one or more cameras; receiving a plurality of checksums associated with one or more previous frames displayed on the screen; updating one or more counters based at least on one or more comparisons of the computed checksum and the plurality of checksums; and causing an alert associated with display of the frame on the screen to be generated based at least on the one or more counters.

2. The method of clause 1, further comprising computing a second checksum for at least a second portion of the frame; updating one or more additional counters based at least on one or more additional comparisons of the computed second checksum and a second plurality of checksums; and causing the alert to be generated based at least on the one or more additional counters.

3. The method of any of clauses 1-2, further comprising: determining the portion of the frame based at least on a first set of settings associated with one or more input channels; and determining the second portion of the frame based at least on a second set of settings associated with the one or more input channels.

4. The method of any of clauses 1-3, wherein the alert is generated based at least on one or more thresholds associated with the one or more counters and the one or more additional counters.

5. The method of any of clauses 1-4, wherein the updating the one or more counters comprises determining that the computed checksum matches a first checksum that is included in the plurality of checksums and corresponds to a most recent frame displayed on the screen; and in response to determining that the computed checksum matches the first checksum, incrementing a first counter included in the one or more counters.

6. The method of any of clauses 1-5, wherein the alert is generated based at least on a comparison of the first counter with a frozen frame limit associated with the one or more views.

7. The method of claim any of clauses 1-6, wherein the updating the one or more counters comprises determining that the computed checksum matches a second checksum that is included in the plurality of checksums and corresponds to an additional frame that is older than the most recent frame; and in response to determining that the computed checksum matches the second checksum, incrementing a second counter included in the one or more counters.

8. The method of any of clauses 1-7, wherein the alert is generated based at least on a comparison of the second counter with a repeated frame limit associated with the one or more views.

9. The method of any of clauses 1-8, wherein the plurality of checksums includes a number of checksum values that corresponds to a depth of a display pipeline associated with generating the frame.

10. The method of any of clauses 1-9, wherein the one or more comparisons are performed during a post-composition processing stage associated with the frame.

11. At least one processor comprising one or more circuits to perform operations comprising computing a checksum for at least a portion of a frame to be displayed on a screen, the frame including one or more views captured using one or more cameras; receiving a plurality of checksums associated with one or more previous frames displayed on the screen; updating one or more counters based at least on one or more comparisons of the computed checksum and the plurality of checksums; and performing one or more operations associated with display of the frame on the screen based at least on the one or more counters.

12. The at least one processor of clause 11, wherein the operations further comprise computing a second checksum for at least a second portion of the frame; updating one or more additional counters based at least on one or more additional comparisons of the computed second checksum and a second plurality of checksums; and causing the alert to be generated based at least on the one or more additional counters.

13. The at least one processor of any of clauses 11-12, wherein the operations further comprise computing one or more additional checksums for one or more portions of a second frame; updating the one or more counters based at least on one or more additional comparisons of the one or more additional checksums and a second plurality of checksums; and causing the second frame to be displayed on the screen based at least on the one or more counters.

14. The at least one processor of any of clauses 11-13, wherein the operations further comprise updating a sequence of checksums corresponding to the plurality of checksums based at least on the one or more comparisons.

15. The at least one processor of any of clauses 11-14, wherein the updating the sequence of checksums comprises upon determining that the computed checksum does not match any checksum included in the sequence of checksums, adding the computed checksum to a most recent position in the sequence of checksums; or upon determining that the computed checksum matches a second checksum that is included in the sequence of checksums and corresponds to an additional frame that is older than the most recent frame, moving the second checksum to the most recent position in the sequence of checksums.

16. The at least one processor of any of clauses 11-15, wherein the one or more operations associated with the display of the frame on the screen comprise at least one of preventing the frame or a subsequent frame from being displayed on the screen, blanking the screen, or outputting a warning associated with the frame.

17. The at least one processor of any of clauses 11-16, wherein the processor corresponds to a display controller for the screen and the screen is included in a vehicle.

18. The at least one processor of any of clauses 11-17, wherein the at least one processor is comprised in at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality content, augmented reality content, or mixed reality content; a system implemented using a robot; a system for performing conversational AI operations; a system implementing one or more large language models (LLMs); a system implementing one or more vision language models (VLMs); a system implementing one or more multi modal language models; a system for generating synthetic data; a system incorporating one or more virtual machines (VMs); a system implemented at least partially in a data center; or a system implemented at least partially using cloud computing resources.

19. In some embodiments, a system comprises one or more processors to compute a checksum for at least a portion of a frame to be displayed on a screen, the frame including one or more views captured using one or more cameras; receive a plurality of checksums associated with one or more previous frames displayed on the screen; update one or more counters based at least on one or more comparisons of the computed checksum and the plurality of checksums; and cause an alert associated with display of the frame on the screen to be generated based at least on the one or more counters.

20. The system of clause 19, wherein the system is comprised in at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality content, augmented reality content, or mixed reality content; a system implemented using a robot; a system for performing conversational AI operations; a system implementing one or more large language models (LLMs); a system implementing one or more vision language models (VLMs); a system implementing one or more multi modal language models; a system for generating synthetic data; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
computing a checksum for at least a portion of a frame to be displayed on a screen, the frame including one or more views captured using one or more cameras;
receiving a plurality of checksums associated with one or more previous frames displayed on the screen;
updating one or more counters based at least on one or more comparisons of the computed checksum and the plurality of checksums; and
causing an alert associated with display of the frame on the screen to be generated based at least on the one or more counters.

2. The method of claim 1, further comprising:
computing a second checksum for at least a second portion of the frame;
updating one or more additional counters based at least on one or more additional comparisons of the computed second checksum and a second plurality of checksums; and
causing the alert to be generated based at least on the one or more additional counters.

3. The method of claim 2, further comprising:
determining the portion of the frame based at least on a first set of settings associated with one or more input channels; and
determining the second portion of the frame based at least on a second set of settings associated with the one or more input channels.

4. The method of claim 2, wherein the alert is generated based at least on one or more thresholds associated with the one or more counters and the one or more additional counters.

5. The method of claim 1, wherein the updating the one or more counters comprises:
determining that the computed checksum matches a first checksum that is included in the plurality of checksums and corresponds to a most recent frame displayed on the screen; and
in response to determining that the computed checksum matches the first checksum, incrementing a first counter included in the one or more counters.

6. The method of claim 5, wherein the alert is generated based at least on a comparison of the first counter with a frozen frame limit associated with the one or more views.

7. The method of claim 5, wherein the updating the one or more counters comprises:
determining that the computed checksum matches a second checksum that is included in the plurality of checksums and corresponds to an additional frame that is older than the most recent frame; and
in response to determining that the computed checksum matches the second checksum, incrementing a second counter included in the one or more counters.

8. The method of claim 7, wherein the alert is generated based at least on a comparison of the second counter with a repeated frame limit associated with the one or more views.

9. The method of claim 1, wherein the plurality of checksums includes a number of checksum values that corresponds to a depth of a display pipeline associated with generating the frame.

10. The method of claim 1, wherein the one or more comparisons are performed during a post-composition processing stage associated with the frame.

11. At least one processor comprising:
one or more circuits to perform operations comprising:
computing a checksum for at least a portion of a frame to be displayed on a screen, the frame including one or more views captured using one or more cameras;
receiving a plurality of checksums associated with one or more previous frames displayed on the screen;
updating one or more counters based at least on one or more comparisons of the computed checksum and the plurality of checksums; and
performing one or more operations associated with display of the frame on the screen based at least on the one or more counters.

12. The at least one processor of claim 11, wherein the operations further comprise:
computing a second checksum for at least a second portion of the frame;
updating one or more additional counters based at least on one or more additional comparisons of the computed second checksum and a second plurality of checksums; and
causing the alert to be generated based at least on the one or more additional counters.

13. The at least one processor of claim 11, wherein the operations further comprise:
computing one or more additional checksums for one or more portions of a second frame;
updating the one or more counters based at least on one or more additional comparisons of the one or more additional checksums and a second plurality of checksums; and
causing the second frame to be displayed on the screen based at least on the one or more counters.

14. The at least one processor of claim 11, wherein the operations further comprise updating a sequence of checksums corresponding to the plurality of checksums based at least on the one or more comparisons.

15. The at least one processor of claim 14, wherein the updating the sequence of checksums comprises:
upon determining that the computed checksum does not match any checksum included in the sequence of checksums, adding the computed checksum to a most recent position in the sequence of checksums; or
upon determining that the computed checksum matches a second checksum that is included in the sequence of checksums and corresponds to an additional frame that is older than the most recent frame, moving the second checksum to the most recent position in the sequence of checksums.

16. The at least one processor of claim 11, wherein the one or more operations associated with the display of the frame on the screen comprise at least one of preventing the frame or a subsequent frame from being displayed on the screen, blanking the screen, or outputting a warning associated with the frame.

17. The at least one processor of claim 11, wherein the processor corresponds to a display controller for the screen and the screen is included in a vehicle.

18. The at least one processor of claim 11, wherein the at least one processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system implementing one or more large language models (LLMs);
a system implementing one or more vision language models (VLMs);
a system implementing one or more multi modal language models;
a system for generating synthetic data;
a system incorporating one or more virtual machines (VMs);
a system implemented at least partially in a data center; or
a system implemented at least partially using cloud computing resources.

19. A system comprising:
one or more processors to:
compute a checksum for at least a portion of a frame to be displayed on a screen, the frame including one or more views captured using one or more cameras;
receive a plurality of checksums associated with one or more previous frames displayed on the screen;
update one or more counters based at least on one or more comparisons of the computed checksum and the plurality of checksums; and
cause an alert associated with display of the frame on the screen to be generated based at least on the one or more counters.

20. The system of claim 19, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system implementing one or more large language models (LLMs);
a system implementing one or more vision language models (VLMs);
a system implementing one or more multi modal language models;
a system for generating synthetic data;
a system incorporating one or more virtual machines (VMs);
a system implemented at least partially in a data center; or
a system implemented at least partially using cloud computing resources.
